(19) United States
(12) Patent Application Publication
(10) Pub. No.: US 2004/0248524 A1
(43) Pub. Date: Dec. 9, 2004

(54) Electronic apparatus having a removable front-face element

(76) Inventor: Arnaud Flegeo, Challes (FR)

Correspondence Address: Philips Electronics North America Corporation, Corporate Patent Counsel, PO Box 3001, Briarcliff Manor, NY, 10510, US

(21) Appl. No.: 10/492,446

(22) PCT Filed: Oct. 15, 2002
(86) PCT No.: PCT/IB02/04299

(30) Foreign Application Priority Data
Oct. 16, 2001 (FR) 0113332

(51) Int. Cl. H04Q 7/20

(52) U.S. Cl. 455/90.3

(57) ABSTRACT

The invention proposes an electronic apparatus (10) of the type having a body (12) which lies in a longitudinal plane and a top face (16) of which receives a removable cladding element (18), the body (12) having a cavity (24) which opens out in an opening (28) produced in at least one other face of the body (12) and which receives a component, in particular a battery, and of the type having a removable cover (32) for closing off the opening (28), characterized in that it has a common element for locking the cladding element (18) and the cover (32) in the mounted position on the body (12).

The invention proposes an electronic apparatus having a removable front-face element.

The invention proposes more particularly an electronic apparatus of the type having a body which lies in a horizontal plane and a top face of which receives a removable cladding element, the body having a cavity which opens out in an opening produced in at least one other face of the body and which receives a component, in particular a battery, and of the type having a removable cover closing off the opening.

There are many items of apparatus of this type such as GSM mobile telephones.

The users of mobile telephones may wish to change the front-face element of their apparatus because it is damaged, or to change the esthetic appearance of the apparatus, an operation which is commonly referred to as “customization”.

As is known, connecting the cladding element to the body of the apparatus consists of the resilient engagement or fitting of the nose of a hook on part of the cladding element in a complementary hollow shape in the body.

Although connecting the body and the cladding element is simple and easy to perform, this solution does not allow easy removal of the cladding element, and in particular without risk of damage.

Another solution consists of using an additional fixing piece for fixing the cladding element. For esthetic reasons, this fixing piece is accessible from the inside of the apparatus. It is then necessary to remove another element, such as the cover, making it possible to gain access to the battery location, in order to be able to access this fixing piece and finally be able to remove the cladding element.

In general terms, this fixing piece is generally fragile and it is then necessary to handle it carefully in order to remove the cladding element.

It will easily be understood that these manipulations make the operation of replacing the cladding element tedious.

In order to provide a solution to this problem, the invention proposes an electronic apparatus which has means of fixing the cladding element to the body which allow mounting and removal of the cladding element which are more simple and without risk of breakage of any part.

The invention therefore proposes an electronic apparatus of the type described above, characterized in that it has a common element for locking the cladding element and the cover in the mounted position on the body.

According to other characteristics of the invention:

the locking element is mounted so as to be able to move with respect to the body in a direction substantially parallel to the longitudinal plane between an unlocked position in which the cover and the cladding element can be separated from the body, and a locked position in which the cover and the cladding element are locked on the body;

the locking element is a part of the cover;

it has elements for locking the cover and the cladding element on the body by cooperation of complementary shapes;

the locking elements include at least one elastically deformable element;

the cover has first fixing means for locking it on the body and second fixing means for locking the cladding element, and the cladding element has means of location in the mounted position on the body;

the opening closed off by the cover is produced at least partly in a front longitudinal end of the body, and the cover has a top part extending substantially in a longitudinal plane, the rear longitudinal end of which receives the second means of locking the cladding element, and the front longitudinal end of which is connected to a bottom part of the cap closing off the opening which receives the first means of locking on the body;

the cover is mounted so as to be able to move with respect to the body in a substantially longitudinal direction.

The invention will be further described with reference to examples of embodiment shown in the drawings to which, however, the invention is not restricted.

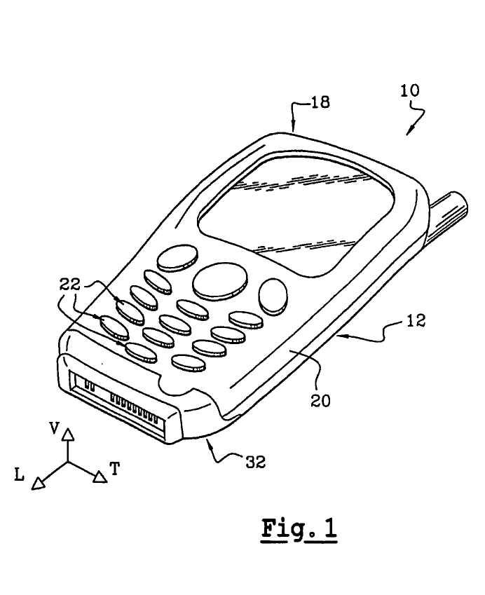

FIG. 1 is a perspective view of an electronic apparatus according to the invention;

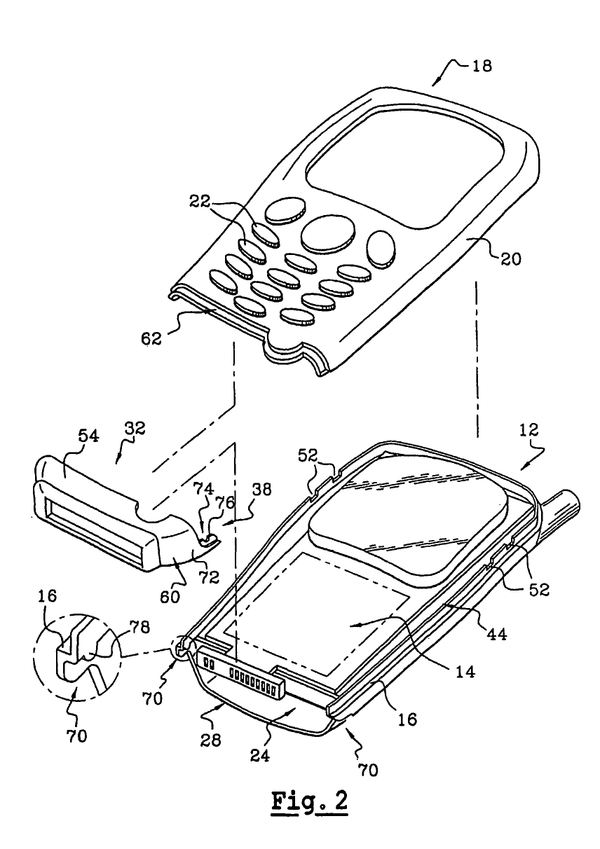

FIG. 2 is an exploded perspective view of the electronic apparatus according to the invention;

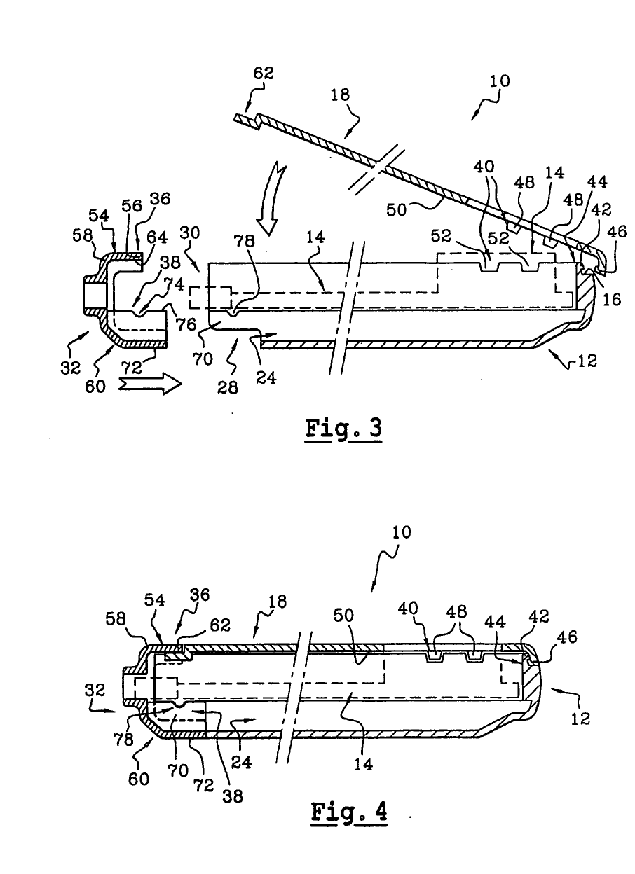

FIG. 3 is a view in longitudinal section and through a vertical plane of an exploded view of the electronic apparatus according to the invention which shows the mounting of the cladding element and of the cover;

FIG.4 is a view in longitudinal section and through a vertical plane of the electronic apparatus according to the invention.

For the description of the invention, the vertical, longitudinal and transverse orientations will be adopted non-limitingly according to the reference frame V, L, T indicated in FIG. 1.

In the following description, identical, similar or analogous elements will be designated by the same reference numbers.

FIGS. 1 and 2 depict an electronic apparatus 10, which may for example be a mobile telephone of the GSM type.

This electronic apparatus 10 has a body 12 which lies in a substantially longitudinal plane. The body 12 receives all the electronic components 12 of the electronic apparatus 10. The top face 16 of the body 12 receives in particular a front-face or cladding element 18.

The cladding element 18 is in the form of a longitudinal half-shell which covers all the top face 16 of the body 12 and which has vertical side walls 20 which bear on facing parts of the top face 16 of the body 12. This cladding element 18 can receive keys 22 of a numeric keypad.

The cladding element 18 is removable, which enables the user to replace it with another one according to his requirements.

The body 12 also has a cavity 24 produced in its bottom part. This cavity 24 receives a component such as for example a battery (not shown).

The battery may be removable in order to be changed or to make it possible to gain access to other electronic components 14. To allow the removal of the battery without its being necessary to entirely dismantle the body 12, the cavity 24 opens out in an opening 28 which is produced partly in a front transverse face 30 (shown in FIG.3) of the body 12.

The electronic apparatus 10 has a cover 32 closing off the opening 28. This cover 32 is removable and can also participate in the personalization of the appearance of the electronic apparatus 10.

To facilitate the mounting and removal of the cladding element 18 and the cover 32, the electronic apparatus 10 has a common element 32 for locking these two elements in the mounted position on the body 12.

The locking element 32 is able to move with respect to the body 12 in a direction substantially parallel to the longitudinal plane, and more particularly here in a longitudinal direction. It is able to move between a locked rear position, illustrated in FIGS. 1 and 4, in which the cladding element 18 and the cover 32 are locked on the body 12, and an unlocked front position, illustrated in FIGS. 2 and 3, in which the cladding element 18 and the cover 32 can easily be separated from the body 12.

According to a preferred embodiment of the invention, the locking element 32 is part of the cover 32 with which it is produced in a single piece, for example by molding. Thus the cover 32 participates in the fixing of the cladding element 18 to the body 12. The mounting and removal of the cladding element 18 is thus facilitated thereby since it suffices to withdraw the cover 32 in order to be able to withdraw the cladding element 18.

The cover 32 is the element allowing the locking of the cladding element 18 on the body 12. It thus has first fixing means 38 for locking it on the body 12, and second fixing means 36 for locking the cladding element 18.

To allow positioning of the cladding element 18 with respect to the body 12, the cladding element 18 has means 40 of locating in the mounted position on the body 12.

These locating means 40 include a low wall or rib 42 which extends vertically upwards from the top face 16 of the body 12. The transverse low wall 42 forms substantially an inverted “U” so that the legs of the U are substantially parallel to the side faces of the body 12, and so that the base of the U is substantially parallel to the front transverse face of the body 12.

When the cladding element 18 is in the mounted position on the body 12, the internal faces of the side walls 20 of the cladding element 18 abut against the external side faces of the low wall 42, thus locating the position of the cladding element 18.

As can be seen in FIGS. 3 and 4, the top end of the front longitudinal end of the low wall 42 has a protrusion 44 which extends outwards. This protrusion 44 cooperates with a lug 46 on the cladding element 18 which extends vertically downwards from the front longitudinal end of the cladding element 18.

Lugs 48 are produced on the bottom face 50 of the cladding element 18. These lugs 48 cooperate with complementary orifices 52, allowing longitudinal positioning of the cladding element 18 with respect to the body 12.

According to the embodiment of the invention depicted in FIGS. 1 to 4, the cover 42 is overall in the form of a U lying on one side, the top arm 54 of which lies substantially in a longitudinal plane. The rear longitudinal end of this top arm 54 receives the second locking means 36 of the cladding element 18. The front longitudinal end 58 of the top arm 54 is connected to the bottom arm 60 of the cover, and this bottom arm 60 enables the opening 28 to be closed off and receives the first means 38 of locking the cover 32 on the body 12.

The first fixing means 38 consist of complementary shapes received by the cladding element 18 and by the cover 32.

As can be seen in FIGS. 3 and 4, the front longitudinal end of the cladding element 18 has a shoulder 62 whose top face is situated in a longitudinal plane situated below the longitudinal plane in which the top face of the cladding element 18 is situated, so as to obtain an overlap of these elements.

The rear longitudinal end 56 of the top part 54 of the cover 32 is complementary to the shoulder on the cladding element, so that the bottom face 64 of the rear longitudinal end 56 of the top part 54 of the cover 32 bears against the top face of the shoulder 62 of the cladding element 18. The cooperation of these two elements 62, 64 allows vertical locking of the cladding element 18 with respect to the body 12.

The second means 36 of fixing the cover 32 to the body 12 consist of a sliding guidance of the cover 32 with respect to the body 12 and a locking of the cover 32 in the front position.

The sliding guidance of the cover 32 is obtained by two vertical side wings 70 each disposed on a side wall of the body 12. When the cover 32 is in position mounted on the body 12, the wings 70 partly cover the external side faces of the longitudinal part 72 of the bottom part 60 of the cover 32.

A notch 74 is provided in a top wall 76 of the longitudinal part 72 of the bottom part 60 of the cover 32. This notch extends vertically downwards from the top face 76 and receives a lug 78 belonging to the body 12. This lug 78 extends vertically downwards and is complementary to the notch 74. The notch 74 and lug 78 are advantageously positioned so as to cooperate when the cover 32 is in the locked position.

The lug 78 is provided such that its bottom end is in a plane situated below the plane in which the top face 76 of the longitudinal part 72 is situated. Thus, to allow sliding of the cover 32, the longitudinal part 72 is elastically deformable so that its top face 76 comes into contact with the bottom end of the lug 78 during sliding of the cover 32.

The elasticity of the longitudinal part 72 is determined so that deformation by the user is possible, whilst preventing any undesired deformation, for example under the effect of the inherent weight of the cover 32 or of the electronic apparatus 10, causing unwanted removal of the cladding element.

The above description is not limiting. This is because it is possible, without departing from the scope of the invention, to make mechanical reversals such as reversal of the notch 74 and lug 78, or to use equivalents.

It will also be understood that the opening 28 can extend over a larger part of the bottom face of the casing, in order to leave clear a larger part of the cavity 24, according to requirements for access to the battery and/or to a subscriber smart card.

The invention therefore allows fixing of the cladding element of an electronic apparatus by another element of the external shell of the electronic apparatus and whose fixing to this other element of the shell facilitates changing of the cladding element.

1. An electronic apparatus (10) of the type having a body (12) which lies in a longitudinal plane and a top face (16) of which receives a removable cladding element (18), the body (12) having a cavity (24) which opens out in an opening (28) produced in at least one other face of the body (12) and which receives a component, in particular a battery, and of the type having a removable cover (32) for closing off the opening (28), characterized in that it has a common element for locking the cladding element (18) and the cover (32) in the mounted position on the body (12).

2. An electronic apparatus (10) as claimed in claim 1, characterized in that the locking element is mounted so as to be able to move with respect to the body (12) in a direction substantially parallel to the longitudinal plane between an unlocked position in which the cover (32) and the cladding element (18) can be separated from the body (12) and a locked position in which the cover (32) and the cladding element (18) are locked on the body (12).

3. An electronic apparatus (10) as claimed in claim 1, characterized in that the locking element is a part of the cover (32).

4. An electronic apparatus (10) as claimed in claim 3, characterized in that it has means of locking the cover (32) and the cladding element (18) on the body (12) by cooperation of complementary shapes.

5. An electronic apparatus (10) as claimed in claim 4, characterized in that the locking means include at least one elastically deformable element.

6. An electronic apparatus (10) as claimed in claim 5, characterized in that the cover (32) has first fixing means (38) for locking it on the body (12) and second fixing means (36) for locking the cladding element (18), and in that the cladding element (18) has means (40) of locating in the mounted position on the body (12).

7. An electronic apparatus (10) according to claim 6, characterized in that the opening (28) closed off by the cover (32) is at least partly produced in a front longitudinal end of the body (12) and in that the cover (32) has a top part (54) extending substantially in a longitudinal plane, the rear longitudinal end (56) of which receives the second fixing means (36) of the cladding element (18), and the front longitudinal end (58) of which is connected to a bottom part (60) of the cover (32) closing off the opening (28) which receives the first means (38) of fixing on the body (12).

8. An electronic apparatus (10) as claimed in claim 7, characterized in that the cover (32) is mounted so as to be able to move with respect to the body (12) in a substantially longitudinal direction.
